(19) United States
(12) Patent Application Publication
(10) Pub. No.: US 2021/0273969 A1
(43) Pub. Date: Sep. 2, 2021

(54) SYSTEMS AND METHODS FOR IDENTIFYING HACKER COMMUNICATIONS RELATED TO VULNERABILITIES

(71) Applicant: Cyber Reconnaissance, Inc., Tempe, AZ (US)

(72) Inventors: Paulo Shakarian, Tempe, AZ (US); Jana Shakarian, Tempe, AZ (US); Harshdeep Singh Sandhu, Tempe, AZ (US); Mohammed Almukaynizi, Tempe, AZ (US); Malay Shah, Tempe, AZ (US)

(21) Appl. No.: 16/899,485

(22) Filed: Jun. 11, 2020

Related U.S. Application Data
(60) Provisional application No. 62/859,940, filed on Jun. 11, 2019.

(51) Int. Cl. H04L 29/06; G06N 7/00; G06K 9/62; G06N 20/10; G06F 40/30

(52) U.S. Cl. CPC H04L 63/1433; G06N 7/005; G06K 9/6256; G06F 40/30; G06K 9/6282; G06N 20/10; G06K 9/6223

(57) ABSTRACT

Embodiments of a computer-implemented system and methods for predicting and/or determining a probability of a cyber-related attack in view of data indicative of hacking discussions are disclosed.

### CROSS REFERENCE TO RELATED APPLICATIONS

This document is a U.S. non-provisional patent application that claims benefit to U.S. provisional application Ser. No. 62/859,940 filed on Jun. 11, 2019, which is incorporated herein by reference in its entirety.

### FIELD

The present disclosure generally relates to predictive cyber technologies; and in particular, to systems and methods for identifying whether known vulnerabilities are going to be discussed or otherwise communicated by hacking actors, and leveraging this information to predict a probability of vulnerability exploits being weaponized.

### BACKGROUND

An increasing number of software (and hardware) vulnerabilities are discovered and publicly disclosed every year. In 2016 alone, more than 10,000 vulnerability identifiers were assigned and at least 6,000 were publicly disclosed by the National Institute of Standards and Technology (NIST). Once the vulnerabilities are disclosed publicly, the likelihood of those vulnerabilities being exploited increases. With limited resources, organizations often look to prioritize which vulnerabilities to patch by assessing the impact it will have on the organization if exploited. Standard risk assessment systems such as Common Vulnerability Scoring System (CVSS), Microsoft Exploitability Index, Adobe Priority Rating report many vulnerabilities as severe and will be exploited to err on the side of caution. This does not alleviate the problem much since the majority of the flagged vulnerabilities will not be attacked.

NIST provides the National Vulnerability Database (NVD) which comprises of a comprehensive list of vulnerabilities disclosed, but only a small fraction of those vulnerabilities (less than 3%) are found to be exploited in the wild—a result confirmed in the present disclosure. Further, it has been found that the CVSS score provided by NIST is not an effective predictor of vulnerabilities being exploited.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a simplified block diagram showing a general computer-implemented system for identifying possible hacker communications about a vulnerability and predicting a possible related exploit being weaponized for the vulnerability.

FIG. 1B is a simplified block diagram showing a first embodiment of the system of FIG. 1A for computing a probability that a given software vulnerability is going to be discussed.

FIG. 1C is a graph illustrating an ROC curve that demonstrates the efficacy of the system described herein.

FIG. 2A is a simplified block diagram showing a second embodiment of the system of FIG. 1A for producing interpretable predictions as an extension of the first embodiment of FIG. 1B.

FIG. 2B is a table that relates to a decision tree that may modeled and trained as described herein.

FIG. 3A is a simplified block diagram of a third embodiment of the system of FIG. 1A configured to compute a vulnerability risk based on the predictions of the first embodiment of FIG. 1B and/or the second embodiment of FIG. 2A.

FIG. 3B is a simplified block diagram that illustrates one method that may be implemented under the third embodiment of FIG. 3A.

FIG. 3C is a graph illustrating an ROC curve that demonstrates the efficacy of the system described herein.

FIG. 4 is a simplified block diagram illustrating another possible method that may be implemented by the system of FIG. 1A to prioritize patching.

FIG. 5 is a simplified block diagram of a general computer-implemented method of applying aspects of the various embodiments of the system of FIG. 1A for computing probabilities of risk of a cyber-related attack, among other features.

FIG. 6 is an example simplified schematic diagram of a computing device that may implement various methodologies described herein.

Corresponding reference characters indicate corresponding elements among the view of the drawings. The headings used in the figures do not limit the scope of the claims.

### DETAILED DESCRIPTION

Aspects of the present disclosure relate to embodiments of a computer-implemented system (hereinafter “system”) and methods for identifying or predicting communications by hackers related to vulnerabilities. In a first embodiment, the system identifies whether known software vulnerabilities are going to be discussed by hacking actors (including malicious and/or non-malicious individuals) in various online hacker communities. Related methods are contemplated; e.g., the system may be leveraged to compute a probability that a given software vulnerability is going to be discussed within some time window in the future within certain online hacker communities. The system may further be leveraged to execute a method to compute a probability that a given software vulnerability is going to be discussed within some time window in the future by a predetermined set of hacking actors; i.e., one or more individual hackers. In a second embodiment, the system is configured to produce human-readable and explainable predictions to why and/or why not certain software vulnerabilities are predicted to be discussed in one or more hacking community websites or other such platforms.

In a third embodiment, the system is configured to compute a vulnerability risk based on predictions from the first embodiment and/or the second embodiment allowing for predictions without using externally-sourced information. In this third embodiment, the system may be used to execute a method to compute the exploitation probability of software vulnerabilities; and the system may be used to execute a method to compute a relative likelihood of exploitation compared to vulnerabilities selected at random. An additional method is contemplated where the system is leveraged to rank software vulnerabilities for patch prioritization.

Introduction and Technical Challenges

Definitions:

Vulnerability: The term vulnerability as used herein may include a piece of software, hardware, or software/hardware combinations, that can be exploited by a hacking actor to perform unauthorized actions that are considered to be violating the confidentiality, integrity, or availability policies of a computing system hosting or executing the technology (software and/or hardware) having the vulnerability susceptible to exploit. Further, the term “vulnerability” can also be used to refer to a class of vulnerabilities and may not only include software flaws (may also include hardware or software/hardware combinations), but other flaws including but not limited to misconfigurations, to organizational practices, hardware, and physical security. It can also be used to describe a class of generalized computer issues that appeal to particular hackers or communities of hackers for purposes of compromising computer systems.

Vulnerability Exploitation: This term refers to an act of taking advantage of a software (and/or hardware) flaw within a computer system. Vulnerability exploitation is often performed using a piece of software, or a sequence of input data, known as an “exploit”.

Proof-Of-Concept (PoC) exploits: This term refers to non-malicious exploits that are developed only to demonstrate how hackers can take advantage of certain software (and/or hardware) flaws. Malicious hackers may leverage PoC exploits to craft weaponized, harmful exploits.

Hacking actors: This term refers to individuals who engage in activities related to software hacking, either with malicious (a.k.a., black-hat hackers) or non-malicious intent (a.k.a., white-hat hackers).

Online hacker communities: This term refers to online environments used by hackers around the globe, such as Chan sites, social media, paste sites, grey-hat communities, Tor, surface web, and even highly access-restricted sites.

Common Vulnerability and Exposure (CVE): This term refers to a unique identifier assigned to each software vulnerability in the National Vulnerability Database (NVD) maintained by the National Institute of Standards and Technology (NIST). The CVE numbering system associated with the NISD follows one of these two formats:
CVE-YYYY-NNNN; and
CVE-YYYY-NNNNNNN.

The “YYYY” portion of the identifier indicates the year in which the software flaw is reported, and the N's portion is an integer that identifies a flaw (e.g., see CVE-2018-4917 related to https://nvd.nist.gov/vuln/detail/CVE-2018-4917, and CVE-2019-9896 related to https://nvd.nist.gov/vuln/detail/CVE-2019-9896).

Common Platform Enumeration (CPE): A Common Platform Enumeration, or CPE, relates to a list of software/hardware products that are vulnerable to a given CVE. The CVE and the respected platforms that are affected, i.e., CPE data, can be obtained from the NVD. For example, the following CPEs are some of the CPEs vulnerable to CVE-2018-4917:
cpe:2.3:a:adobe:acrobat_2017:*:*:*:*:*:*:*:*
cpe:2.3:a:adobe:acrobat_reader_dc:15.006.30033:*:*:*:classic:*:*:*
cpe:2.3:a:adobe:acrobat_reader_dc:15.006,30060:*:*:*:classic:*:*:*

Common vulnerability scoring system (CVSS): This term refers to a scoring system that captures the severity level of software vulnerabilities based on the technical characteristics such as the ease of exploitation and an approximation of impact it would leave if it is exploited. CVSS ranges from 0 to 10 (the most severe score). The CVSS base score is computed from the CVSS base vector, which is composed of two sub-scores, the Exploitability metrics and the Impact metrics. Each sub-score measures different technical characteristics related to the vulnerability. For example, the Exploitability metrics includes the Attack Vector metric, which explains how a vulnerability can be exploited. It can take one of the values: Network, Adjacent, Local, or Physical.

Technical Challenges: Information technology (IT) administrators lack sufficient technical means for efficiently identifying and practically addressing possible vulnerabilities of a technology configuration such as determining how to approach a given vulnerability (versus another). A given IT environment may be potentially susceptible to thousands of security vulnerabilities (at least those identifiable via the NVD). While the NVD and CVSS provides baseline information about some threats, there is insufficient technology presently available that might allow IT administrators to actually make sense of and intelligently leverage such information to apply responsive measures and prioritize patches or other fixes, and predict actual attacks based on the specifics of a given technology configuration.

General Specifications of Computer-Implemented System Responsive to Technical Challenges

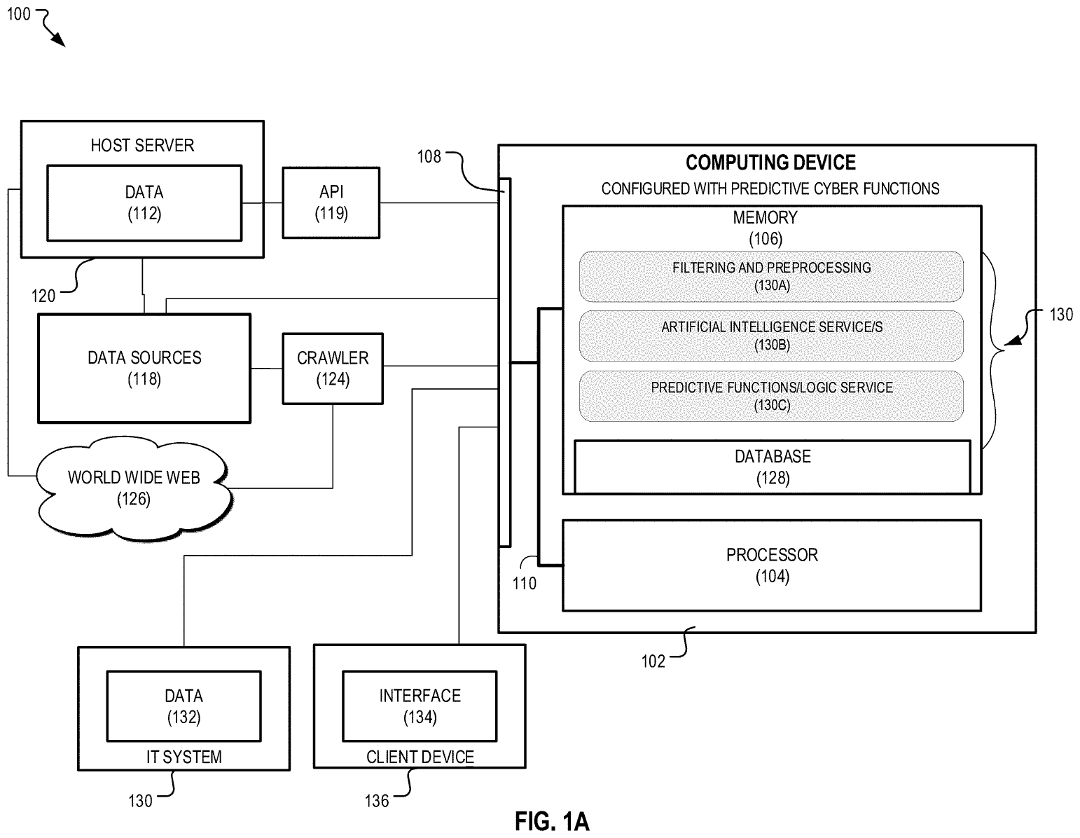

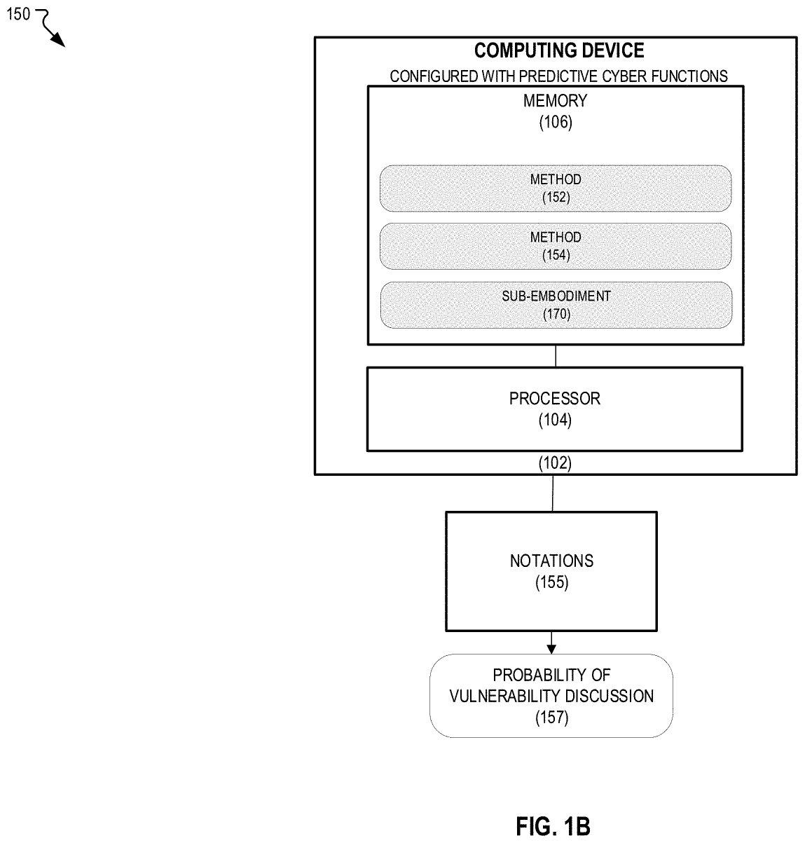

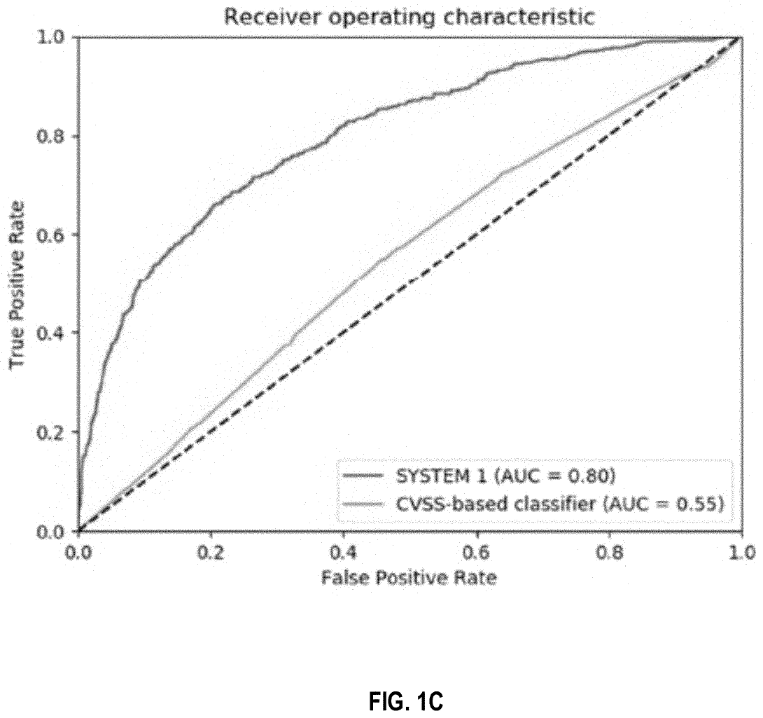

Referring to FIG. 1, an inventive concept responsive to the aforementioned technical challenges may take the form of a computer-implemented system, designated system 100, comprising any number of computing devices or processing elements. In general, the system 100 leverages artificial intelligence to implement cyber predictive methods to e.g., identify whether known vulnerabilities are going to be communicated among hacking actors, and leverage this information to predict the probability of exploits being weaponized for such vulnerabilities. While the present inventive concept is described primarily as an implementation of the system, it should be appreciated that the inventive concept may also take the form of tangible, non-transitory, computer-readable media having instructions encoded thereon and executable by a processor, and any number of methods related to embodiments of the system described herein.

In some embodiments, the system 100 comprises (at least one of) a computing device 102 including a processor 104, a memory 106 of the computing device 102 (or separately implemented), a network interface (or multiple network interfaces) 108, and a bus 110 (or wireless medium) for interconnecting the aforementioned components. The network interface 108 includes the mechanical, electrical, and signaling circuitry for communicating data over links (e.g., wires or wireless links) within a network (e.g., the Internet). The network interface 108 may be configured to transmit and/or receive data using a variety of different communication protocols, as will be understood by those skilled in the art.

As indicated, via the network interface 108 or otherwise, the computing device 102 is adapted to access data 112 from a host server 120 or other remote computing device and the data 112 may be generally stored/aggregated within a storage device (not shown) or locally stored within the memory 106. The data 112 includes any information about hacker communications, information about cybersecurity events across multiple technology platforms referenced herein, information about known vulnerabilities associated with hardware and software components, any information from the NVD including updates, and may further include, without limitation, information gathered regarding possible hardware and software components/parameters being implemented by a given technology configuration associated with some entity such as a company, and information about any vulnerabilities and possible related exploits. A technology configuration may include software and may define software stacks and individual software applications/pieces, may include hardware, and combinations thereof, and may generally relate to an overall network or IT infrastructure environment including telecommunications devices and other components, computing devices, and the like.

As shown, the computing device 102 is adapted, via the network interface 108 or otherwise, to access the data 112 from directly and/or indirectly from various data sources 118 (such as the deep or dark web (D2web), or the general Internet including hacking actors, hacking communities, or any sources of information related to hacking). In some embodiments, the computing device 102 accesses the data 112 by engaging an application programming interface 119 to establish a temporary communication link with a host server 120 associated with the data sources 118. Alternatively, or in combination, the computing device 102 may be configured to implement a crawler 124 (or spider or the like) to extract the data 112 from the data sources 118 without aid of a separate device (e.g., host server 120). Further, the computing device 102 may access the data 112 from any number or type of devices providing data (or otherwise taking the form of the data sources 118) via the general Internet or World Wide Web 126 as needed, with or without aid from the host server 120.

The data 112 may generally define or be organized into datasets or any predetermined data structures which may be aggregated or accessed by the computing device 102 and may be stored within a database 128. Once this data is accessed and/or stored in the database 128, the processor 104 is operable to execute a plurality of services 130, encoded as instructions within the memory 106 and executable by the processor 104, to process the data so as to determine correlations and generate rules or predictive functions, as further described herein. The services 130 of the system 100 may generally include, without limitation, a filtering and preprocessing service 130A for, in general preparing the data 112 for machine learning or further use; an artificial service 130B comprising any number or type of artificial intelligence functions for modeling the data 112 (e.g., natural language processing, classification, neural networks, linear regression, etc.) and/or feature extraction and any other related methods; and a predictive functions/logic service 130C that formulates predictive functions and outputs one or more values suitable for reducing risk, such as a probability that a given software vulnerability is going to be discussed within some time window within certain hacker-related communities, and the like, as further described herein. The plurality of services 130 may include any number of components or modules executed by the processor 104 or otherwise implemented. Accordingly, in some embodiments, one or more of the plurality of services 130 may be implemented as code and/or machine-executable instructions executable by the processor 104 that may represent one or more of a procedure, a function, a subprogram, a program, a routine, a subroutine, a module, an object, a software package, a class, or any combination of instructions, data structures, or program statements, and the like. In other words, one or more of the plurality of services 130 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 106), and the processor 104 performs the tasks defined by the code.

As shown, the computing device 102 may be in operable communication with some device associated with at least one of an information technology (IT) system 130 or enterprise network. The IT system 140 may include any system architecture, IT system, or configuration where it is desired to assess possible vulnerabilities to the IT system 140, rank these vulnerabilities or otherwise generate informative metrics from the same, and apply the functionality described herein to reduce risk to the IT system 140. The IT system 140 may further include data 142 defining some configuration of possible hardware and/or software components (e.g., various software stacks) that may be susceptible to vulnerabilities.

As further shown, the system 100 may include a graphical user interface (“interface”) 134 which may be presented by way of a portal or gateway embodied as an API, a browser-based application, a mobile application, or the like. The interface 134 may be executable or accessible by a remote computing device (e.g., client device 136) and may provide predefined access to aspects of the system 100 for any number of users. For example, accessing the interface 134, a user may provide information about an external IT system (such as data 142) so that the computing device 102 can process this information according to the plurality of services 130 and return some output value useful for reducing vulnerability and exploit risk to the IT system 140.

### Exemplary Embodiments of the System (100)

Given the above information, various embodiments and sub-embodiments of the system 100 shall now be described that are responsive to the technical challenges set forth herein. It should be appreciated that the embodiments of the system 100 are not mutually exclusive such that the system 100 may be configured using any number or type of features described for each embodiment (i.e., embodiments may share features), and/or may be configured with select features of various embodiments for specific applications. In the following embodiments of the system 100, the computing device 102 accesses the data 112, preprocesses the data 112 (using the filtering and preprocessing functions 130A or otherwise), and extracts features or parameters from the data 112 to formulate models and predictive methods/functions as described in relation to each embodiment of the system 100. The models or functions, which may comprise computer-readable instructions within the memory 106 and executable by the processor 104, may then be executed by the processor 104 in view of additional data to ultimately output some value predicting, e.g., hacker activity or some related metric.

### First Embodiment

Referring to FIG. 1B, in a first embodiment 150 of the system 100, the system 100, via the computing device 102 or otherwise, is configured to identify whether known software vulnerabilities are going to be discussed by hacking actors (malicious or non-malicious) in various online hacker communities. In this embodiment, the computing device 102 accesses the data 112 and is configured to execute a method 152 which may be implemented as a computer-executable function or model stored within the memory 106 and executable by the processor 104 under the first embodiment 150 of the system 100.

Method 152 (Method 1.a)

In general, the method 152, when executed by the computing device 102, computes a probability (157 in FIG. 1B) that a given software vulnerability is going to be discussed within some time window in the future within certain online hacker communities. Under the method 152, the following notations (155 in FIG. 1B) and general expressions may be defined as follows: given a set S of online sources of hacking communities, a set of V of known software vulnerabilities, a time window [symbol] , and a software vulnerability database db (that can be created from any sources of vulnerability information databases such as the NVD and discernable via access to the data 112 or otherwise); a probability p can be computed under the method 152. The probability p is a probability that a software vulnerability v∈V is going to be discussed in any online source in S within [symbol] time-points after v's public disclosure date. The probability p can be computed using different statistical learning approaches including but not limited to:
Non-parametric approaches such as k-nearest neighbor; and/or
Parametric learning approaches such as Support Vector Machine

Generally, parametric statistical learning approaches fits a model based on the characteristics of vulnerabilities using a labeled training dataset from db. From the characteristics of v, they produce an assignment to either the positive class (i.e., v will be discussed in any source in S) or the negative class (i.e., v will not be discussed in any source in S) along with some confidence score (or a probability) quantifying the level of confidence of such assignment. Non-parametric approaches may not fit models. Rather, they leverage the characteristics of v and some similarity or distance measures to assign a class label similar to the closets vulnerabilities, i.e., having similar characteristics.

The characteristics of a vulnerability v can be transformed into numerical representations, i.e., can be processed by the computing device 102, using different approaches. For example, categorical data fields can be transformed into numerical representations using one-hot-encoding, i.e., each possible value of a given field is transformed into a new field that can take a value of 0 or 1. For example, the field Attack Vector can take one value of Network, Adjacent, Local, or Physical. Assuming it has the value Network for a vulnerability v. After applying one-hot-encoding to that field, it can then be transformed into 4 new fields, i.e., Attack Vector Network, Attack Vector Adjacent, Attack Vector Local, Attack Vector Physical. Vulnerability v will have the value 1 for Attack Vector Network, and 0's for the other 3 fields. Moreover, textual description of vulnerabilities can be transformed into numerical representations using natural language processing techniques, including but not limited to:
Frequency based techniques such as TF-IDF
Context based techniques such as deep-learning models (e.g., doc2vec)

Other ways to derive p under the method 152 include:
Using the CVSS score
A probability derived from a probability distribution. For example, random guessing based on a uniform distribution

Method 154 (Method 1.b)

The first embodiment 150 of the system 100 may further be configured to execute a method 154 which may be implemented as a computer-executable function or model stored within the memory 106 and executable by the processor 104. The method may be executed to compute the probability that a given software vulnerability is going to be discussed within some time window in the future by a certain set of hacking actors. The method 154 may include the notations (155) present in the method 152. In particular, under the method 154, we assume the existence of a set of hacking actors, denoted Actors. The probability p that a software vulnerability v∈V is going to be discussed by any individual a∈Actors and within [symbol] time-points after v's public disclosure can be computed using statistical learning approaches (as explained in the description of method 152).

Sub-Embodiment 170

A concrete example using real-world vulnerability data shall now be presented as a sub-embodiment 170 of the first embodiment 150. This sub-embodiment 170 demonstrates the practicality of an approach following the specifications explained in the present embodiment 150 of the system 100 (and may include aspects of both method 152 and method 154 described herein). In particular, the used approach under the sub-embodiment 170 demonstrates a significant performance improvement over a conventional way of computing the probability p of hacker discussions (e.g., deriving p from the CVSS base score).

In other words, in this sub-embodiment 170, we seek to demonstrate the performance improvement over a conventional approach by showing that an approach following the specifications of first embodiment 150 of the system 100 significantly increase area under the receiver operating characteristic curve, a common measure to gauge the performance of binary classifiers. A set of vulnerability characteristics and definitions are provided below as exemplary preliminaries for an exemplary implementation of the sub-embodiment 170.

Vulnerability Characteristics and Definitions:
S is a set of hacking community sources obtained; |S|=411.
Actors is a set with a mixture of malicious and non-malicious actors. Each hacker of Actors has discussed at least one vulnerability (by referencing its CVE) in any of the sources S during a period starting from January, 2017 through December, 2017. |Actors|=2762.
V is a set of sample software vulnerabilities disclosed within a period from January of 2017 through March of 2018, and obtained from the NVD. |V|=11,630, about 20% (2,360) were discussed in S and by members of Actors.
Δt=∞
db is a vulnerability information database table. Each row corresponds to a single vulnerability in V, and each vulnerability in V maps to a single row. The columns of db include:
   a tf-idf 100-dimension-representation of the textual description of the vulnerability obtained from the NVD. For example, CVE-2018-4917 is described as: “Adobe Acrobat and Reader versions 2018.009.20050 and earlier, 2017.011.30070 and earlier, 2015.006.30394 and earlier have an exploitable heap overflow vulnerability. Successful exploitation could lead to arbitrary code execution in the context of the current user.”
   The CPE information is transformed into one hot encoding/numerical representation.
   The CVSS base score. For example, CVE-2018-4917 has a CVSS base score of 10.0
   The CVSS base vector. Each metric is transformed into one hot encoding representation.

Methodology of the sub-embodiment 170: In this sub-embodiment 170, we choose to use binary Logistic Regression (LR) as the statistical learning approach. LR is a parametric model that user the sigmoid function, which maps a real number into a value between 0 and 1. The LR model is trained on a randomly selected subset of the vulnerabilities in V containing 80% of V's elements (11,630 vulnerabilities), and tested on the remaining 20% of V's elements (2,326 vulnerabilities). The class labels (discussed vs. not discussed) are determined based on whether vulnerabilities are explicitly mentioned, by referencing their CVEs, in the content of hacker postings.

LR Model: When the LR model is tested on a testing sample v∈V, it predicts a probability p of v being assigned the positive class; i.e., will be discussed within the hacking community sources in the future. We use the known receiver operating characteristic curve (ROC) (shown in FIG. 1C) to visually show the approach described in this embodiment outperforms a conventional approach—using a probability derived from the CVSS base score. The receiver operating characteristic curve is a visual plot that shows the false positive rate against the true positive rate at different decision boundaries of a binary classifier. We also report, in the plot, the area under the ROC curve (AUC). A perfect classifier has an AUC of 1.0 while a classifier that randomly assigns labels has an AUC of around 0.5.

Conventional Approach: is noted that under a conventional approach, we derive the probability from the CVSS base score of the vulnerabilities in the testing set. The probability derived from the CVSS base score is computed by simply dividing the CVSS base score by 10 (the maximum score).

Referring to FIG. 1C, the ROC curve illustrated and described shows that implementation of the system 100 as discussed provides an improvement of more than 45% over the conventional CVSS-based approach. In other words, FIG. 1C indicates a significant increase area under the receiver operating characteristic curve, a common measure to gauge the performance of binary classifiers, highlighting the performance improvement of the system 100 over conventional approaches.

### Second Embodiment

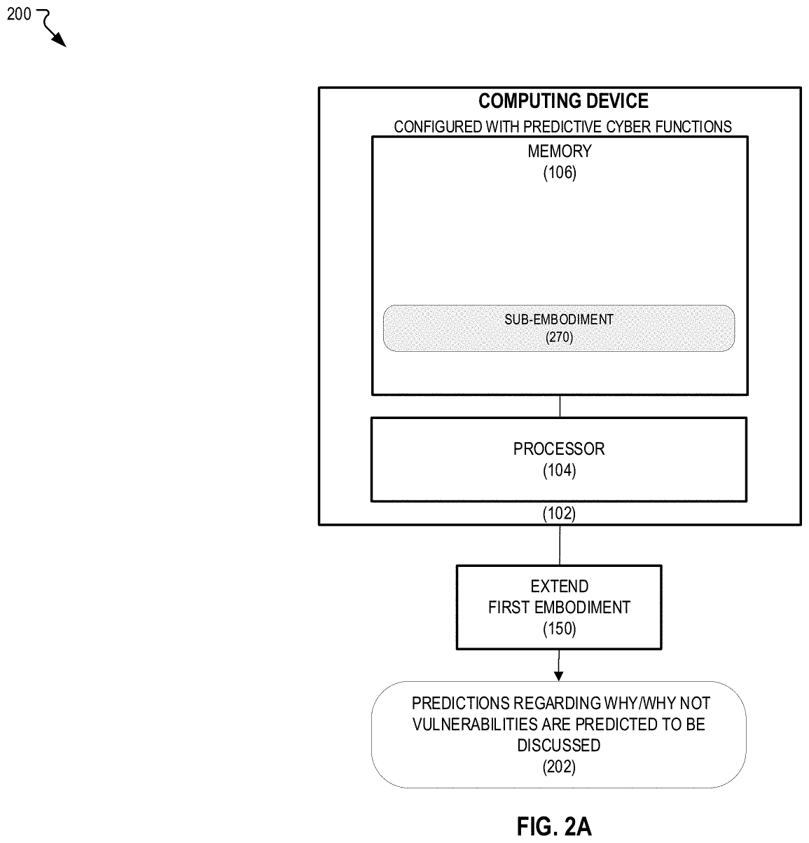

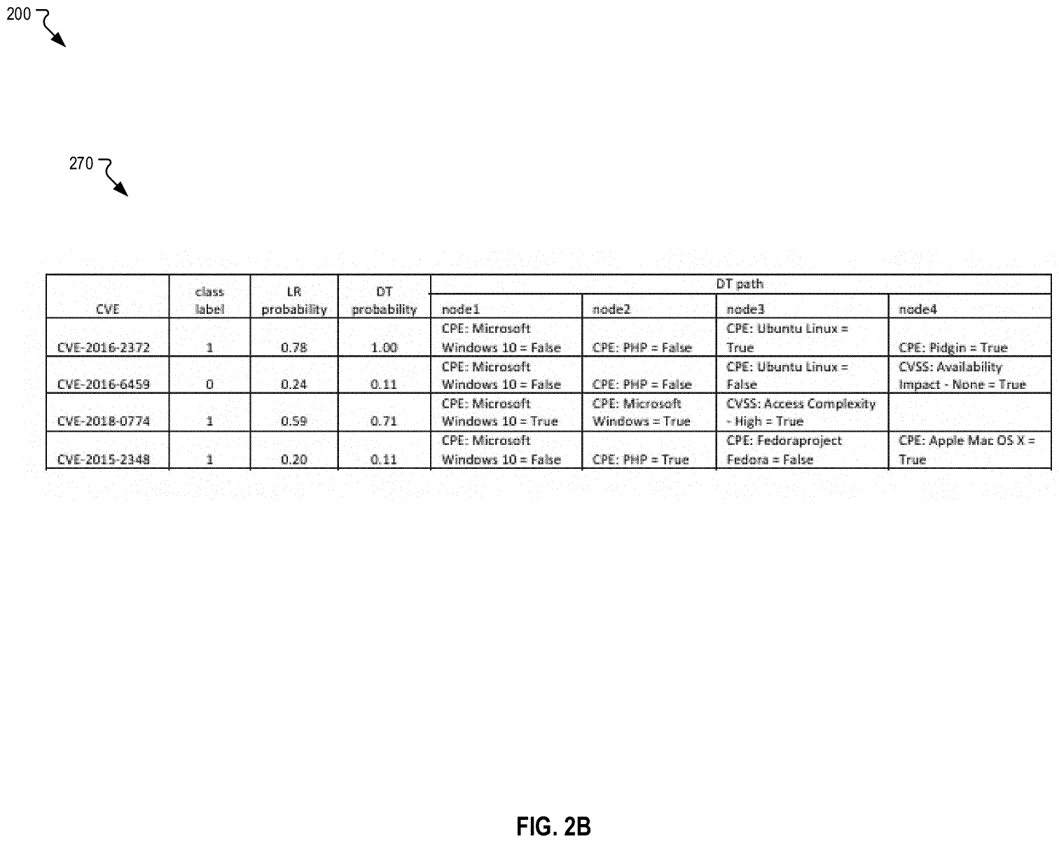

Referring to FIG. 2A, in a second embodiment 200 of the system 100, the system 100, via the computing device 102 or otherwise, is configured to generate human-readable and explainable predictions (202 in FIG. 2A) relating to why and/or why not certain software vulnerabilities are predicted to be discussed in hacking community websites or platforms where discussions take place. As in the first embodiment 150, with the second embodiment 200 of the system 100, the processor 104 is provided with access to any number and type of computer-readable executable instructions stored in the memory 106 to execute functionality described herein in the context of the second embodiment 200. In general, the processor 104 of the second embodiment 200 of the system 100 may be configured to execute at least some functionality or aspects thereof related to the first embodiment 150, but provides an extension beyond the first embodiment 150.

In other words, the second embodiment 200 derives from an understanding that it is not guaranteed the statistical learning approaches explained and implemented under the first embodiment 150 of the system 100 are going to produce interpretable predictions; i.e., a human expert may not be able to understand the reasoning that led to producing certain probability values. There are a few different statistical learning approaches that are inherently transparent such as decision table and decision tree models, and approaches that are based on logic programming frameworks, which allow for extension of the learning process by incorporating the knowledge of domain experts and/or knowledge transferred from other statistical learning models. Therefore, the present second embodiment 200 extends the functionality of the first embodiment 150 by adding interpretable predictors that do not necessarily depend on the approach selected for the first embodiment 150 of the system 100. Different predictors can be used including:
Decision tree/table-based models such as J48 and M5Rules; and/or
Rule-learning approaches such as probabilistic logic programming.

Under the second embodiment 200 of the system 100, an extended version of the sub-embodiment 170 is defined as sub-embodiment 270.

Sub-Embodiment 270 (Extension of Sub-Embodiment 170):

Vulnerability Characteristics: Referring to FIG. 2B, we extend the characteristics and definitions explained in sub-embodiment 170 by training a decision tree (DT) model on the training dataset, and test it on the testing data set. Each testing sample is assigned a probability based on its characteristics. From the testing samples, we choose four vulnerabilities and show the path that led to the DT decision. The prefix at each node (e.g., CPE and CVSS) indicates the category of characteristics that determines what branch of the DT to follow.

### Third Embodiment 300

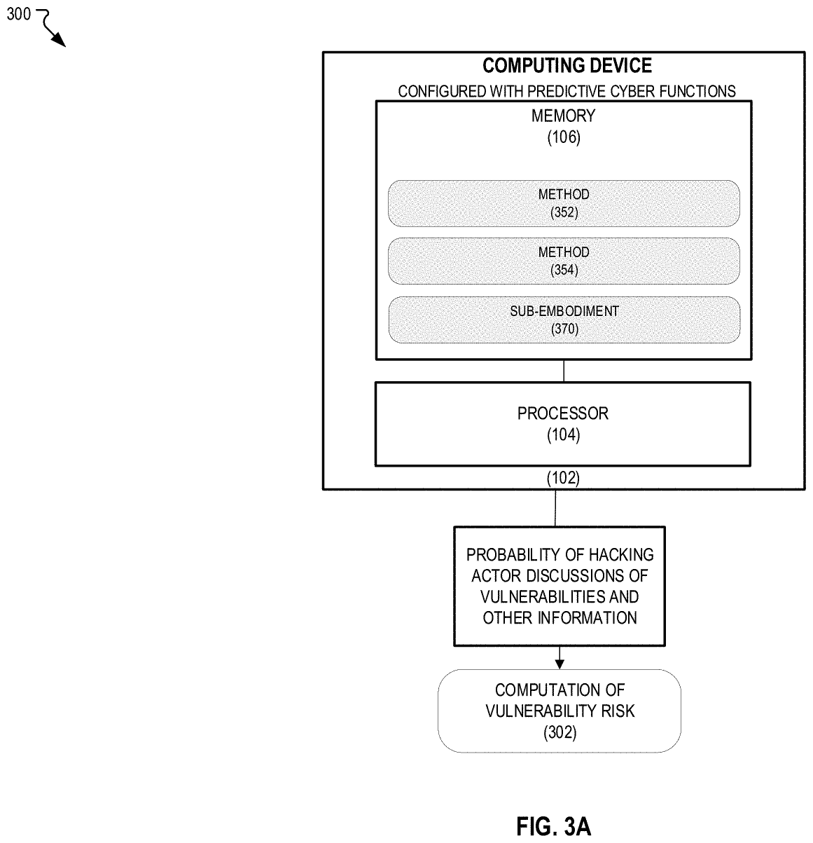

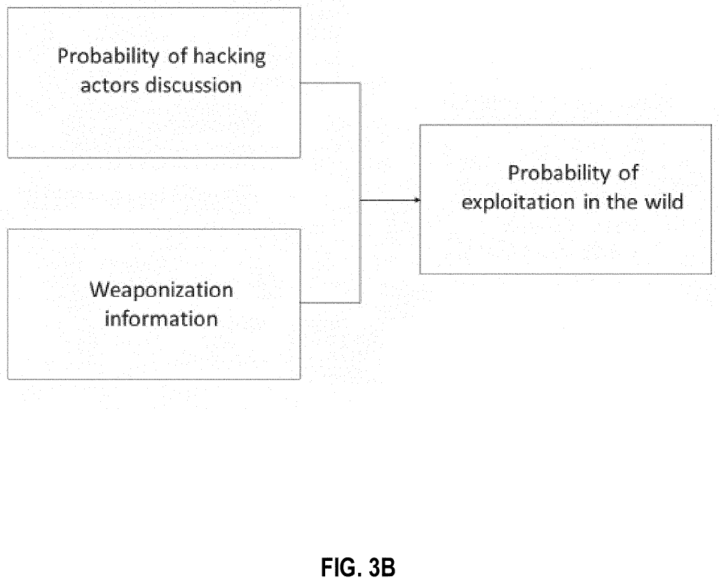

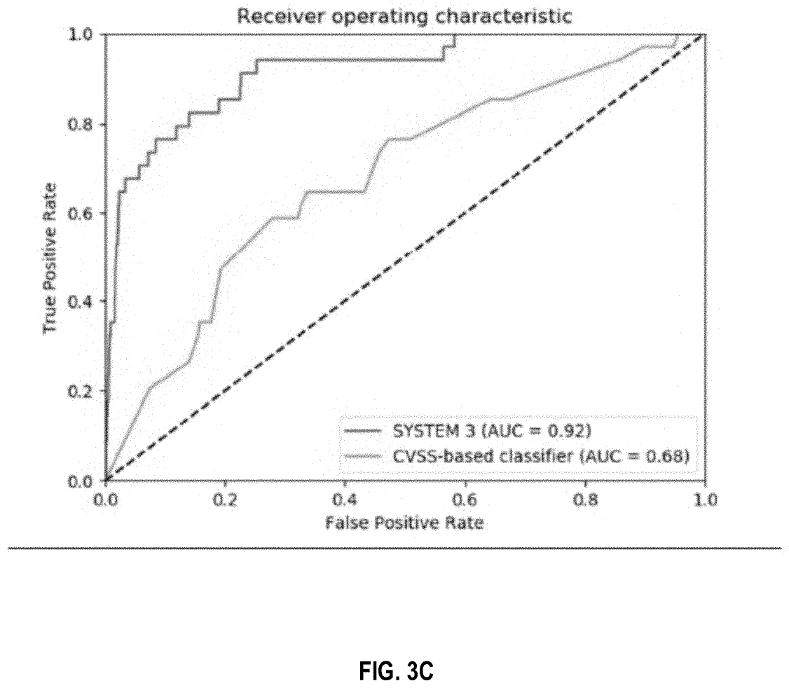

Referring to FIG. 3A, in a third embodiment 300 of the system 100, the system 100, via the computing device 102 or otherwise, is configured to derive a computation of a vulnerability risk (302 in FIG. 3A) based on the predictions set forth in the description of the first embodiment 150 and/or the second embodiment 200 allowing for prediction without using externally-sourced information. With the third embodiment 300 of the system 100, the processor 104 is provided with access to any number and type of computer-readable executable instructions stored in the memory 106 to execute functionality described herein in the context of the third embodiment 300.

The third embodiment 300 quantifies the risk of software vulnerabilities in terms of probability (e.g., method 352) and relative likelihood of vulnerability exploitation in the wild (method 354) to support a patch prioritization process. The vulnerability risk (302) is computed based on information about the probability of hacking actor discussions of vulnerabilities (first embodiment 150 and/or second embodiment 200) as well as other information related to the existence of PoC exploits.

The present third embodiment 300 differs from the other embodiments of the system 100 in two aspects: (1) the hacker information (e.g., information derived from hacker social networks, and information derived from the textual content of darkweb postings) does not inform the model, and (2) it does not use local system information (e.g., software inventory, firewall configurations, network traffic data) and is based purely on what the hackers are looking to do in the future.

Method 352 (Method 3.a)

Referring to FIG. 3B, the third embodiment 300 includes a method 352 which may be implemented as a computer-executable function or model stored within the memory 106 and executable by the processor 104. When executing the method 352, given (1) some information about the availability of PoC exploits obtained from sources such as Metasploit exploit modules (https://metasploit.help.rapid7.com/docs/modules) and ExploitDB (https://www.exploit-db.com), (2) information about successful vulnerability weaponization attempts such as those detected in the wild an obtained from sources such as Symantec attack signatures (https://www.symantec.com/security response/attacksignatures), and (3) the results of approaches following the specifications of the first embodiment 150 and/or the second embodiment 200, the present method 352 computes a probability of future exploitation in the wild.

Different modeling approaches based on the probability theory can be used to estimate the probability of exploitation in the wild conditioned on variables derived from the mentioned sources. For example, one can employ an approach that computes the conditional probability distribution by applying the Bayes theorem with a strong independence assumption between the variables. This approach is known as the Naive Bayes (NB) classifier.

Sub-Embodiment 370

Vulnerability Characteristics: Employing the same train/test vulnerability splits as in the sub-embodiment 170, the sub-embodiment 370 defines the following characteristics for each vulnerability:
Information about whether a PoC exists on ExploitDB (binary, denoted PoC)
Information about whether an exploit module exists on Rapid7's website (binary, denoted ms f_module)
Information about whether a successful exploitation is observed in the wild by Symantec (binary, denoted weaponized)
The training dataset has information about whether the vulnerability is discussed by hacking actors (binary, denoted discussed)
The testing dataset has the probability being discussed by hacking actors, obtained from the first embodiment 150 and/or the second embodiment 200 of the system 100 (denoted p)

On the subset of vulnerabilities that are discussed by hacking actors in the training dataset, an NB model may be implemented to learn the probability of successful exploitation conditioned upon two variables: (1) whether a PoC exploit exists, and (2) whether a Rapid7 module exists.

On the testing dataset, the probability of future successful exploitation of a vulnerability is computed by multiplying the probability of being discussed in the hacking community sources (from the first embodiment 150 or the second embodiment 200) by the results of the NB model, which assumes the vulnerability is already discussed, as follows:

P(weaponized)=P(weaponized|discussed=true, PoC, exploit_module)*p

Method 354 (Method 3.b)

The third embodiment 300 further includes a method 354 which may be implemented as a computer-executable function or model stored within the memory 106 and executable by the processor 104. When executing the method 354, a relative likelihood of exploitation compared to vulnerabilities selected at random can be computed.

More specifically, the relative likelihood of future successful exploitation of a given vulnerability compared to a vulnerability selected at random can be determined by dividing the probability of successful exploitation (method 352) by the prior probability of vulnerability exploitation in the wild. In the training dataset, this quantity is 0.013.

Referring to FIG. 3C, similar to the first embodiment 150, an ROC curve is plotted and illustrated and the AUC is reported as shown. FIG. 3C demonstrates that the proposed approach significantly outperforms the baseline approach with an increase of over 35% in AUC.

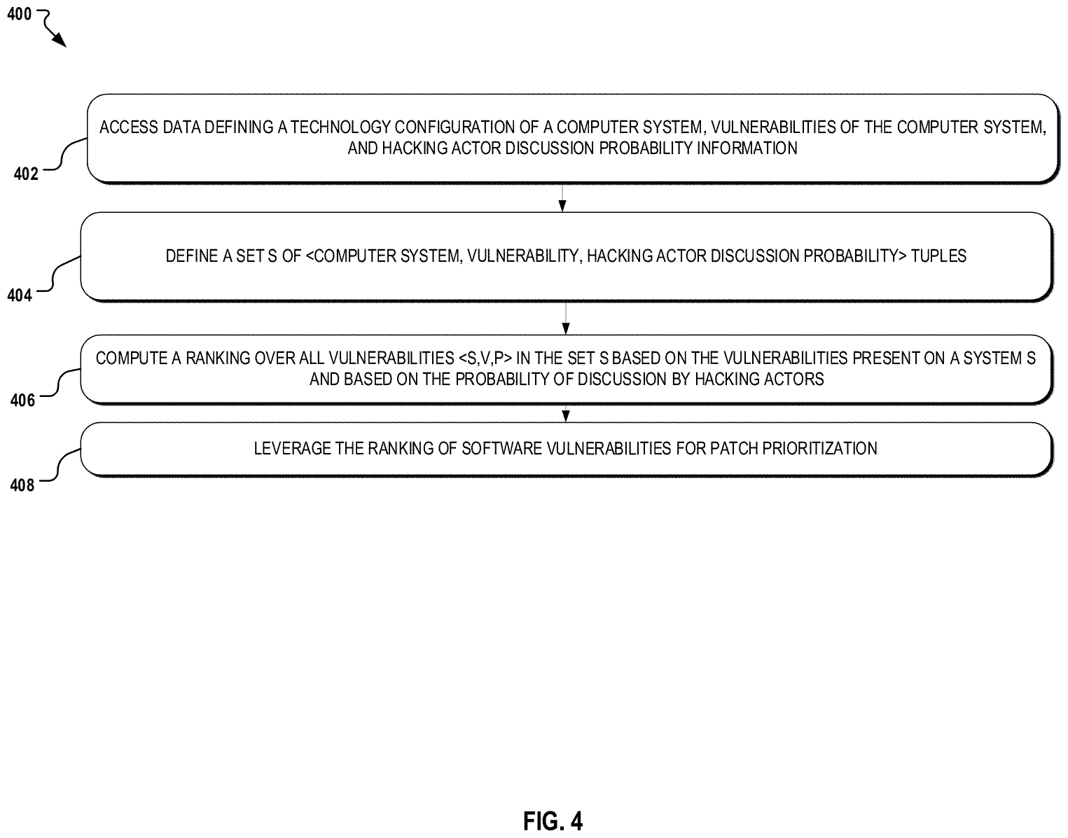

Method 400: Referring to FIG. 4 a method 400 is further contemplated which may be implemented as a computer-executable function or model stored within the memory 106 and executable by the processor 104. In general, the method 400 computes a ranking of software vulnerabilities which may be advantageous for, e.g., patch prioritization (block 408).

Under the method 400, referencing blocks 402, 404, and 406 of FIG. 4, given a set S of <computer system, vulnerability, hacking actor discussion probability>tuples, we define a ranking over all vulnerabilities <s,v,p> in set S based on the vulnerabilities present on a system s and based on the probability of discussion by hacking actors (i.e., p, taken from the first embodiment 150 of the system 100).

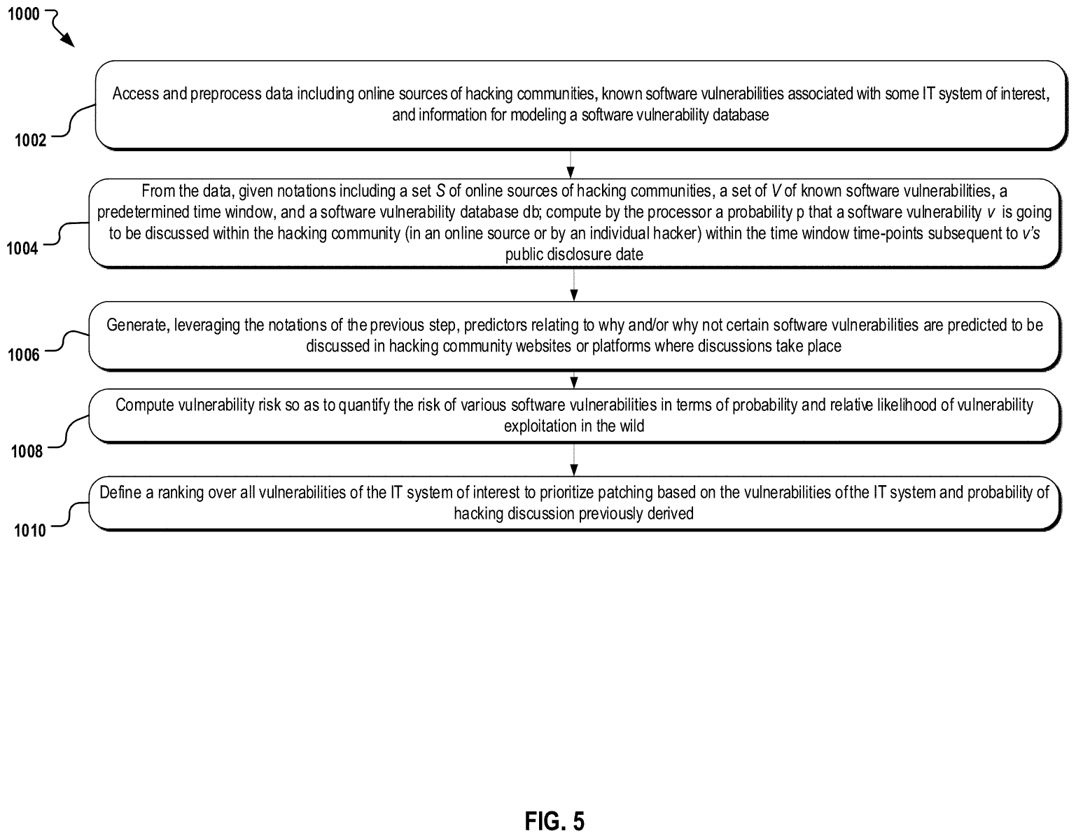

Referring now to a process flow diagram 1000 of FIG. 5, one possible implementation utilizing the various embodiments of the system 100 described herein is shown. Referring to block 1002, a first dataset, or any number datasets of the data 112 may be accessed, collected, or acquired by the computing device 102 as illustrated in FIG. 1A. The first dataset of the data 112 may include information from, by non-limiting examples, dark web forums, blogs, marketplaces, intelligence threat APIs, data leaks, data dumps, the general Internet or World Wide Web (126), and the like, and may be acquired using web crawling, RESTful HTTP requests, HTML parsing, or any number or combination of such methods. The data 112 may further include information originating from the NVD including CPEs, corresponding CVEs, and CVSS scores. The data 112 may further include discussions from hacker social media websites, blogs, forums, or any other hacker discussion sources. In addition, a second dataset may be accessed by the computing device 102 from data 142 associated with the IT system 140. The data 142, as previously described, may include information about software, hardware, and/or combinations thereof implemented by an IT system 140. In some embodiments, a user may provide the second dataset or otherwise make the second dataset available to the computing device 102 by implementing the interface 134 via the client device 136.

In one specific embodiment, using the API 119, the first dataset may be acquired from a remote database hosted by, e.g., host server 120. In this embodiment, the host server 120 gathers D2web data from any number of D2web sites or platforms and makes the data accessible to other devices. More particularly, the computing device 102 issues an API call to the host server 120 using the API 119 to establish a RESTful Hypertext Transfer Protocol Secure (HTTPS) connection. Then, the data 112 can be transmitted to the computing device 102 in an HTTP response with content provided in key-value pairs (e.g., JSON).

Once accessed, the first dataset and/or the second dataset may be preprocessed by, e.g., cleaning, formatting, sorting, or filtering the information, or modeling the information in some predetermined fashion so that, e.g., the data 112 is compatible or commonly formatted between the datasets. For example, in some embodiments, the first dataset or the second dataset may be processed by applying text translation, topic modeling, content tagging, social network analysis, or any number or combination of artificial intelligence methods such as machine learning applications. Any of such data cleaning techniques can be used to filter content of the first dataset from other content commonly discussed in the D2web such as drug-related discussions or pornography.

Utilizing any number of artificial intelligence methods such as natural language processing, the processor 104 scans the data 112 to identify components of the second dataset associated with CPE identifiers corresponding to CPEs of the first dataset. More specifically, by non-limiting example, the processor 104 conducts a character or keyword search of the second dataset defining the components/inventory of the IT system 140 in view of CPE identifiers and corresponding CPEs from the first dataset. In this manner, the processor 104 identifies possible components of the IT system 140 that are affiliated with at least one CPE (and possible CVE).

In addition, the processor 104 may be used to map at least one of the components of the IT system 140 to a CVE based on an identified CPE associated with the IT system 140. For example, an exemplary technology configuration of the IT system 140 may define a computing environment running Windows Server 2008 on an IBM computing device, and it may be discovered via intelligence from the first dataset that such an exemplary technology configuration is susceptible or vulnerable to an Attack Vector V (which may include, for example, malware, exploits, the known use of common system misconfigurations, or other attack methodology), based on e.g., historical cyber-attacks. In either case, this functionality outputs at least one CVE/attack vector that poses at least some threat to the IT system 140; and/or the functionality can be leveraged to identify a plurality or set of CVEs/attack vectors that may be ranked, aggregated, and/or minimized.

In this step, the processor 104 may be leveraged to generate or access, based on the data 112, a database db that organizes vulnerability information in a table. The database db may be structured to define or represent characteristics of vulnerabilities as described herein. For example, the database db may include textual descriptions of vulnerabilities (derived from the NVD or otherwise) and/or transformations of these descriptions to numerical representations.

Referring to block 1004 and to FIGS. 1B-1C and associated description, the processor 104 may be used to generate a model and define notations from the data 112 including a set S of online sources of hacking communities, a set of V of known software vulnerabilities, a predetermined time window, and a software vulnerability database db. The processor may then compute a probability p that a software vulnerability v is going to be discussed within the hacking community (in an online source or by an individual hacker) within the time window time-points subsequent to v's public disclosure date.

Referring to block 1006 and FIGS. 2A-2B and associated description, as an optional step, predictors relating to why or why not certain software vulnerabilities are predicted to be discussed among sources related to hacking including hacking community websites or individual hacking actors can be generated utilizing the processor 104. For example, a decision tree (DT) model or other such model can be generated to model explainable information about the statistical learning approaches used to generate the probability.

Referring to block 1008 and to FIGS. 3A-3C and associated description, a vulnerability risk can be computed to quantity the risk of various software vulnerabilities in terms of probability and relative likelihood of vulnerability exploitation in the wild. Referring to block 1010 and FIG. 4, the aforementioned steps of the process flow diagram 1000 may be repeated to assess multiple vulnerabilities, and the vulnerabilities can be ranked to prioritize patching based on the probability of each vulnerability being discussed in the wild.

### Exemplary Computing Device

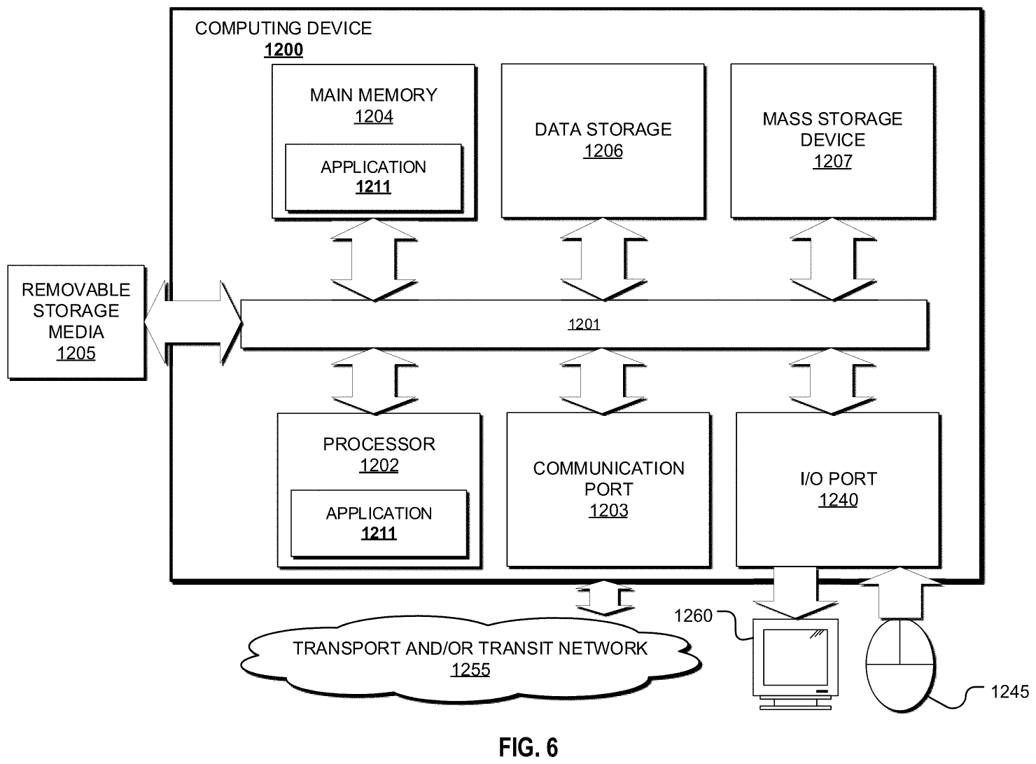

Referring to FIG. 6, a computing device 1200 is illustrated which may take the place of the computing device 102 and be configured, via one or more of an application 1211 or computer-executable instructions, to execute functionality described herein. More particularly, in some embodiments, aspects of the predictive methods herein may be translated to software or machine-level code, which may be installed to and/or executed by the computing device 1200 such that the computing device 1200 is configured to execute functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A device for predicting hacker communications to predict the probability of vulnerability exploits being weaponized, comprising:
a processor;
a network interface in operable communication with the processor, the network interface operable for communicating with a network and providing the processor with access to data including information about vulnerabilities and exploits associated with the vulnerabilities; and
a memory storing a set of instructions executable by the processor, the set of instructions, when executed by the processor, operable to:
preprocess the data to extract parameters from the data including sources of hacking discussions,
generate, from the data, a database mapping known software vulnerabilities to known exploits,
define a training dataset from the database to represent characteristics of the vulnerability,
compute, given a set S of the sources of hacking discussions, a set V of the vulnerabilities, a time window, and the database, a probability that a software vulnerability of the set of vulnerabilities is going to be discussed by or within any of the sources of hacking discussions within the time window time-points subsequent to a public disclosure data of the vulnerability.

2. The device of claim 1, wherein the processor is operable to compute the probability using a non-parametric approach including a k-nearest neighbor model.

3. The device of claim 1, wherein the processor is operable to compute the probability using a parametric learning approach such as a support vector machine.

4. The device of claim 1, wherein the sources include one or more individual hackers or hacker communities.

5. The device of claim 1, wherein the processor transforms a textual description of the vulnerability into a numerical representation using natural language processing to represent characteristics of the vulnerability.

6. The device of claim 5, wherein the natural language processing includes frequency based-techniques including TF-IDF.

7. The device of claim 5, wherein the natural language processing includes context based techniques such as deep-learning models.

8. The device of claim 1, wherein the processor trains a decision tree model on the training dataset to provide an interpretable predictor related to the probability.

9. A method to predict the probability of vulnerability exploits being weaponized based on predicted hacker communications, comprising:
accessing, by a processor, data including information about a set of sources associated with a hacking community, and actors having discussed at least one vulnerability in any of the set of sources during a predetermined timeframe;
generating, by the processor, a database defining known vulnerability information; and
computing, given the set S of sources, a set V of vulnerabilities, a time window, and the database, a probability that a software vulnerability of the set of vulnerabilities is going to be discussed by or within any of the sources of hacking discussions within the time window time-points subsequent to a public disclosure data of the vulnerability.

10. The method of claim 9, further comprising generating a binary logistic regression (LR) model as a statistical learning approach to compute the probability of the vulnerability being discussed within the hacking community in the future.

11. The method of claim 10, wherein the binary LR model is a parametric module that uses the Sigmoid function which maps a real number into a value between 0 and 1.

12. The method of claim 11, further comprising, applying, by the processor , the binary LR model to predict a probability p of the vulnerability being assigned a positive class indicating that the vulnerability will be discussed in the future.

13. The method of claim 9, wherein each row of the database corresponds to a single vulnerability of the set V, and each vulnerability of the set V maps to a single row of the database.

14. The method of claim 9, wherein the columns of the database include a term frequency-inverse document frequency (TF-IDF) representation of textual description of the vulnerability.

15. A tangible, non-transitory, computer-readable media having instructions encoded thereon for predicting hacker communications, such that a processor executing the instructions is operable to:
access vulnerability characteristics defining variables, the vulnerability characteristics including information about whether a proof of concept (PoC) exists for a vulnerability, information about whether an exploit module exists, information about whether a successful exploitation of the vulnerability has been observed, a training dataset that includes information about whether the vulnerability is discussed by hacking actors, and a testing dataset that includes a probability of the vulnerability being discussed;
train, using a subset of vulnerabilities of the training dataset, a model to learn a probability of successful exploitation conditioned upon at least some of the variables of the vulnerability characteristics including a first variable defining whether a PoC exists for the vulnerability and a second variable defining whether an exploit module exists; and
compute a probability of future exploitation of the vulnerability by leveraging the training dataset to multiply a probability of the vulnerability being discussed by results of the model.

16. The tangible, non-transitory, computer-readable media of claim 15 having further instructions encoded thereon for predicting hacker communications, such that a processor executing the instructions is further operable to utilize an NB model as the model, or a classifier.

17. The tangible, non-transitory, computer-readable media of claim 15 having further instructions encoded thereon for predicting hacker communications, such that a processor executing the instructions is further operable to compute a relative likelihood of future successful exploitation of the vulnerability compared to a vulnerability selected at random by dividing the probability of successful exploitation by a prior probability of vulnerability exploitation.
